(19) United States
(12) Patent Application Publication
(10) Pub. No.: US 2026/0313774 A1
(43) Pub. Date: Oct. 8, 2026

(54) LIGHTING DEVICE CONTROL SYSTEM

(71) Applicant: ZHENGZHOU DEWENWILS NETWORK TECHNOLOGY CO., LTD., Zhengzhou (CN)

(72) Inventors: Weijia HUANG, Zhengzhou (CN); Peng WANG, Zhengzhou (CN)

(73) Assignee: ZHENGZHOU DEWENWILS NETWORK TECHNOLOGY CO., LTD., Zhengzhou (CN)

(21) Appl. No.: 19/321,596

(22) Filed: Sep. 8, 2025

(30) Foreign Application Priority Data
Apr. 7, 2025 (CN) 202520640969.9
Aug. 27, 2025 (CN) 202521836619.6

(51) Int. Cl. H05B 47/185; H05B 45/33; H05B 45/38; H05B 47/155; H05B 47/165; H05B 47/19

(52) U.S. Cl. CPC H05B 47/185; H05B 45/33; H05B 45/38; H05B 47/155; H05B 47/165; H05B 47/19

(57) ABSTRACT

A lighting device control system includes a host side and device sides, the host side includes a power transformer, a power supply encoding circuit, a signal receiving module, and a microcontroller unit. An output terminal of the power transformer is connected to a voltage input terminal of the power supply encoding circuit, a second voltage output terminal of the power supply encoding circuit is connected to a voltage input terminal of the MCU, a signal output terminal of the signal receiving module is connected to a signal input terminal of the MCU, and a signal output terminal of the MCU is connected to a signal input terminal of the power supply encoding circuit; and each of the device sides includes a decoding circuit, a drive circuit, and light emitting diode lamp beads. The present disclosure has the effects of simplifying the wiring of a lighting system.

### CROSS-REFERENCE TO RELATED APPLICATIONS

This application claims priority to Chinese Patent Application No. 202520640969.9, filed on Apr. 7, 2025, and Chinese Patent Application No. 202521836619.6, filed on Aug. 27, 2025. All of the aforementioned applications are incorporated herein by reference in their entireties.

### TECHNICAL FIELD

The present disclosure relates to the technical field of lighting, and more particularly, to a lighting device control system.

### BACKGROUND

As an important component of modern intelligent lighting, a lighting control system has been widely used in the fields such as architecture, landscape, and home furnishings. The traditional lighting control system typically adopts an architecture where independent power lines and signal lines are separated, that is, lighting equipment is powered through the power line while relying on additional communication lines (such as RS-485 and DALI) to transmit control signals.

Although the above solution can realize basic control functions, control is basically achieved by using two power lines for supplying power and a plurality of communication lines for transmitting control signals, which will cause the problems such as complex wiring, high cost, and poor expansibility, and especially in the scenarios of multi-device networking or long-distance deployment, the problems such as line redundancy and signal susceptibility to interference are particularly prominent. Redundant data cables increase the material costs, as well as the labor and time costs in the process of laying and construction. Interference to control signals may cause remote lighting devices to be out of control, and thus the lighting effect is poor.

### SUMMARY

In order to reduce line redundancy and improve signal transmission stability, the present disclosure discloses a lighting device control system, which includes a host side and a device side; the host side receives a control command of the lighting mode expected by a user via a signal receiving module; a microcontroller unit (MCU) generates an encoded control signal according to the control command, and outputs the encoded control signal to a power supply encoding circuit; the power supply encoding circuit encodes the voltage output by a power transformer according to the encoded control signal to form a carrier voltage, which is then output to the device side through a first voltage output terminal; a decoding circuit in the device side decodes the carrier voltage to obtain a lamp bead control signal; and a drive circuit performs voltage stabilization on the carrier voltage to obtain stable light emitting diode (LED) lamp bead driving voltage and current, so that the lighting operation of each LED lamp bead can be realized based on the lamp bead control signal and driving voltage.

The technical solutions adopted by the present disclosure to solve the technical problems are as follows.

A lighting device control system is characterized by including a host side and at least one device side, where

the host side includes a power transformer, a power supply encoding circuit, a signal receiving module, and a microcontroller unit (MCU); an output terminal of the power transformer is connected to a voltage input terminal of the power supply encoding circuit, a signal output terminal of the signal receiving module is connected to a signal input terminal of the MCU, and a signal output terminal of the MCU is connected to a signal input terminal of the power supply encoding circuit; and

the device side includes a decoding circuit, a drive circuit, and light emitting diode (LED) lamp beads, where a first voltage output terminal of the power supply encoding circuit is separately connected to a signal input terminal of the decoding circuit and a voltage input terminal of the drive circuit by means of a dual-wire power line, a signal output terminal of the decoding circuit is connected to a signal input terminal of the drive circuit, and an output terminal of the drive circuit is connected to the LED lamp beads.

Optionally, the power supply encoding circuit includes a metal-oxide-semiconductor (MOS) field-effect transistor, a first direct current to direct current (DC/DC) conversion circuit, a second DC/DC conversion circuit, and an isolation diode;

a gate electrode of the MOS field-effect transistor is connected to the signal output terminal of the MCU, a source electrode of the MOS field-effect transistor is connected to the output terminal of the power transformer, and a drain electrode of the MOS field-effect transistor and a cathode of the isolation diode are connected to a live wire of the dual-wire power line, serving as the first voltage output terminal of the power supply encoding circuit;

an input terminal of the first DC/DC conversion circuit is connected to the output terminal of the power transformer, and an output terminal of the first DC/DC conversion circuit is separately connected to an anode of the isolation diode and an input terminal of the second DC/DC conversion circuit; and

an output terminal of the second DC/DC conversion circuit is connected to a voltage input terminal of the MCU, and the output terminal of the second DC/DC conversion circuit serves as a second voltage output terminal of the power supply encoding circuit.

Optionally, an output voltage at the output terminal of the first DC/DC conversion circuit is less than an output voltage of the power transformer and greater than a loop voltage of the power transformer.

Optionally, the output voltage at the output terminal of the first DC/DC conversion circuit is greater than an operating voltage of the device side.

Optionally, an output voltage at the first voltage output terminal of the power supply encoding circuit is a square wave voltage formed by superposition of the output voltage of the power transformer and the output voltage of the first DC/DC conversion circuit.

Optionally, the second voltage output terminal of the power supply encoding circuit is connected to the voltage input terminal of the MCU.

Optionally, the second voltage output terminal of the power supply encoding circuit is also connected to a voltage input terminal of the signal receiving module.

Optionally, the MCU includes a first MCU and a second MCU;

a signal input terminal of the first MCU is connected to the signal output terminal of the signal receiving module, and a signal output terminal of the first MCU is connected to a signal input terminal of the second MCU; and

a signal output terminal of the second MCU is connected to the MOS field-effect transistor in the power supply encoding circuit.

Optionally, the decoding circuit includes a voltage regulator circuit and a decoding chip, where an input terminal of the voltage regulator circuit is connected to the first voltage output terminal of the power supply encoding circuit, an output terminal of the voltage regulator circuit is connected to a signal input terminal of the decoding chip, and a signal output terminal of the decoding chip is connected to a signal input terminal of a driver chip.

Optionally, the drive circuit includes a third DC/DC conversion circuit and the driver chip, where a voltage output terminal of the third DC/DC conversion circuit is connected to a voltage input terminal of the driver chip, and an output terminal of the driver chip is connected to the LED lamp beads.

The beneficial effects of the present disclosure are as follows.

By coupling a power supply voltage with coded signals through the power supply encoding circuit, power supply and signal transmission are completed simultaneously by using the dual-wire power line, which eliminates the need for independent communication lines in the traditional lighting control systems, greatly reduces the number of cables and the complexity of wiring, is especially suitable for multi-lighting device control scenarios, and reduces construction and maintenance costs.

To achieve a hierarchical power supply design, the first DC/DC conversion circuit provides the output voltage higher than the loop voltage for the device side to ensure the signal integrity during long-distance transmission; and the second DC/DC conversion circuit provides stable low-voltage power supply for the MCU to avoid power supply noise affecting the control logic.

The power supply encoding circuit superimposes the output voltage of the power transformer and the output voltage of the first DC/DC conversion circuit into a carrier voltage carrying square wave signals for output through the combination of the MOS field-effect transistor and the isolation diode, forming coded signals with distinct high and low levels. The decoding circuit on the device side filters out voltage fluctuation noise through the voltage regulator circuit to ensure the accurate parsing of control commands, thus avoiding malfunctions caused by voltage ripple or load mutation.

### BRIEF DESCRIPTION OF THE DRAWINGS

FIG. 1 is an overall structural diagram of a lighting device control system according to the present disclosure.

FIG. 2 is a schematic circuit diagram of a power supply encoding circuit in the lighting device control system according to the present disclosure.

FIG. 3 is a schematic diagram of a square wave signal carried by a carrier voltage in the lighting device control system according to the present disclosure.

FIG. 4 is a schematic structural diagram of a button module in the lighting device control system according to the present disclosure.

FIG. 5 is a schematic structural diagram of a wireless transceiver module in the lighting device control system according to the present disclosure.

FIG. 6 is a schematic structural diagram of double MCUs in the lighting device control system according to the present disclosure.

FIG. 7 is a schematic structural diagram of a wireless fidelity (WiFi) communication module in the lighting device control system according to the present disclosure.

FIG. 8 is a schematic circuit diagram of a device side in the lighting device control system according to the present disclosure.

### DETAILED DESCRIPTION OF THE EMBODIMENTS

The present disclosure will further be described below with reference to the accompanying drawings and embodiments.

The concept, specific structure and technical effects of the present disclosure will be described clearly and completely hereinafter with reference to the embodiments and accompanying drawings to facilitate the thorough understanding of the purpose, features, and effects of the present disclosure. Apparently, the described embodiments are only a part rather than all of the embodiments of the present disclosure. Based on the embodiments of the present disclosure, all other embodiments obtained by those skilled in the art without making creative efforts shall fall within the protection scope of the present disclosure. In addition, all the connections/connecting relationships involved in this patent do not simply refer to the direct connections of components, but to better connection structures formed by adding or removing connecting accessories according to the specific implementation situations. The various technical features in the creation of the present disclosure may be interactively combined without conflicting with each other.

In addition, if there are descriptions related to “first”, “second”, and the like in the embodiments of the present disclosure, the descriptions of “first”, “second”, and the like are only used for descriptive purposes, and cannot be understood as indicating or implying their relative importance or implying the number of indicated technical features. Therefore, the features defined with “first” and “second” may explicitly or implicitly include at least one of these features. Secondly, the technical solutions of various embodiments can be combined with each other, which must be based on what those of ordinary skill in the art can achieve. When the combination of the technical solutions is contradictory or impossible to achieve, it should be considered that the combination of such technical solutions does not exist and is not within the scope of protection of the present disclosure.

Referring to FIG. 1, the present disclosure provides a lighting device control system, including a host side and at least one device side, where the host side includes a power transformer, a power supply encoding circuit, a signal receiving module, and an MCU; the power transformer is connected to an input terminal of the power supply encoding circuit; a first voltage output terminal of the power supply encoding circuit is connected to the device side, and a second voltage output terminal thereof is connected to a voltage input terminal of the MCU; a signal output terminal of the signal receiving module is connected to a signal input terminal of the MCU; and a signal output terminal of the MCU is connected to a signal input terminal of the power supply encoding circuit.

The power transformer may be a universal power converter that meets the specification requirements, or may be a transformer that meets the specification requirements for a certain type of lighting device, and is configured to provide the voltage and power adapted to the lighting device control system provided in this embodiment, such as a landscape lamp, with an operating voltage being 12 V direct current (DC) voltage. For example, a power transformer that converts an alternating current (AC) voltage (AC120V or AC220V) into a DC voltage (such as 12 V or more) may be selected, or a power transformer that outputs a low-voltage AC voltage (such as an AC voltage of 12 V or more) may be selected, with the only need to add a corresponding AC/DC conversion circuit on the host side.

In practical products, all modules on the host side may be integrated in a control box; alternatively, the power transformer may be arranged separately, and the remaining modules are integrated in a control box; and the two arrangement ways can be selected according to the actual needs, which are not subjected to the limitations of this embodiment.

The signal receiving module is used for receiving operation commands for users to select or control a lighting mode, generating initial signals based on the operation commands, and sending the initial signals to the MCU. After receiving the initial signals, the MCU processes the initial signals to form encoded control signals, and controls the power supply encoding circuit to encode an unmodulated voltage VH output by the power transformer by means of the encoded control signals.

The unmodulated voltage VH is encoded by the power supply encoding circuit to form a carrier voltage VOUT, and the first voltage output terminal of the power supply encoding circuit outputs the carrier voltage VOUT to the device side through a live wire of a dual-wire power line, so that the device side is enabled to perform a corresponding lighting operation based on the carrier voltage VOUT.

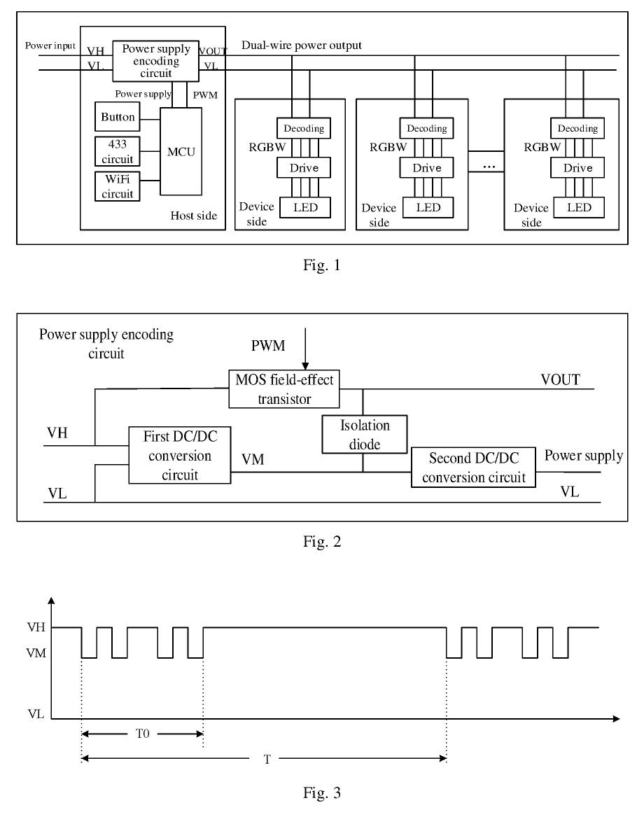

Specifically, referring to FIG. 2, the power supply encoding circuit includes an MOS field-effect transistor, a first DC/DC conversion circuit, a second DC/DC conversion circuit, and an isolation diode, where a gate electrode of the MOS field-effect transistor is connected to the signal output terminal of the MCU, a source electrode thereof is connected to a positive pole of the power transformer, and a drain electrode thereof and a cathode of the isolation diode are connected to the live wire of the dual-wire power line; and the voltages output by the power transformer and the first DC/DC conversion circuit are superimposed as an output voltage of the first voltage output terminal of the power supply encoding circuit.

An input terminal of the first DC/DC conversion circuit is connected to the voltage output terminal of the power transformer, and an output terminal of the first DC/DC conversion circuit is separately connected to an anode of the isolation diode and an input terminal of the second DC/DC conversion circuit. An output terminal of the second DC/DC conversion circuit is connected to the voltage input terminal of the MCU, and the output terminal of the second DC/DC conversion circuit serves as the second voltage output terminal of the power supply encoding circuit.

Specifically, the positive pole of the output terminal of the power transformer outputs the unmodulated voltage VH, and a negative pole thereof serves as a loop voltage VL. The first DC/DC conversion circuit converts the unmodulated voltage VH and the loop voltage VL, and outputs an intermediate voltage VM through the output terminal of the first DC/DC conversion circuit. In this embodiment, the intermediate voltage VM is less than the unmodulated voltage VH output by the power transformer and greater than the loop voltage VL. The isolation diode is used for isolating the unmodulated voltage VH from the intermediate voltage VM to prevent the unmodulated voltage VH from being directly input to the output terminal of the first DC/DC conversion circuit. If the isolation diode is not provided, when the MOS field-effect transistor is turned on, the unmodulated voltage VH will be directly input to the output terminal of the first DC/DC conversion circuit and the input terminal of the second DC/DC conversion circuit, so that the current of the first DC/DC conversion circuit is reversed, and the input voltage of the second DC/DC conversion circuit surges, causing damage to chips of the first and second DC/DC conversion circuits.

Since the unmodulated voltage VH output by the power transformer and the intermediate voltage VM of the first DC/DC conversion circuit are different in magnitude, an output voltage of a first voltage output terminal of an encoding control circuit is a carrier voltage VOUT carrying square wave signals, composed of a high level VH and a low level VM.

The source electrode of the MOS field-effect transistor is connected to the positive pole of the power transformer, so that when the gate electrode of the MOS field-effect transistor is connected, that is, the MOS field-effect transistor is turned on, the drain electrode of the MOS field-effect transistor outputs the unmodulated voltage VH. Since the unmodulated voltage VH is greater than the intermediate voltage VM, the carrier voltage VOUT is equal to the unmodulated voltage VH. When the gate electrode of the MOS field-effect transistor is disconnected, that is, the MOS field-effect transistor is turned off, the carrier voltage VOUT is equal to the intermediate voltage VM.

The gate electrode of the MOS field-effect transistor is connected to the signal output terminal of the MCU, and the signal output terminal of the MCU outputs the processed encoded control signals. The gate electrode of the MOS field-effect transistor is controlled to be connected to disconnected via the encoded control signals to achieve the encoding of the carrier voltage VOUT.

Referring to FIG. 3, it is a schematic diagram of the square wave signal carried in the carrier voltage VOUT with the unmodulated voltage VH as the high level and the intermediate voltage VM as the low level in this embodiment. In this embodiment, the intermediate voltage VM is set to be greater than the operating voltage of the device side to avoid the situation that the operating voltage of the device side is insufficient due to power loss during transmission. T0 is a coding control cycle of a lighting device, and T is a lighting cycle of the lighting device. In actual use, the coding control cycle T0 of a lighting mode selected by a user will be much smaller than the lighting cycle T of the lighting device. Therefore, under the setting of this embodiment, the power supply of the lighting device on the device side will not be affected.

Specifically, the input terminal of the second DC/DC conversion circuit is connected to the output terminal of the first DC/DC conversion circuit for the conversion of the intermediate voltage VM; the intermediate voltage VM is converted into an operating voltage of the MCU, and is output to the MCU through the second voltage output terminal (i.e., the output terminal of the second DC/DC conversion circuit); and therefore, there is no need to provide other power supplies for the MCU, and the power transformer in this embodiment not only supplies power to the device side, but also meets the power demand of the MCU.

Taking a setting of using a landscape lamp as a lighting device as an example, this embodiment provides a feasible solution. For example, the unmodulated voltage VH output by the power transformer is set to 24 V DC voltage, the loop voltage VL is set to 0 V, the intermediate voltage VM is set to 15 V, and an operating voltage of the landscape lamp is set to 12 V. The unmodulated voltage VH is converted into the intermediate voltage VM of 15 V by the first DC/DC conversion circuit, and then converted into a direct current voltage of 3.3 V by a second DC/DC conversion chip to supply power to the MCU.

Specifically, the signal receiving module mentioned in this embodiment may be at least one of a button module, a wireless transceiver module, and a WiFi communication module, which will be described in detail below.

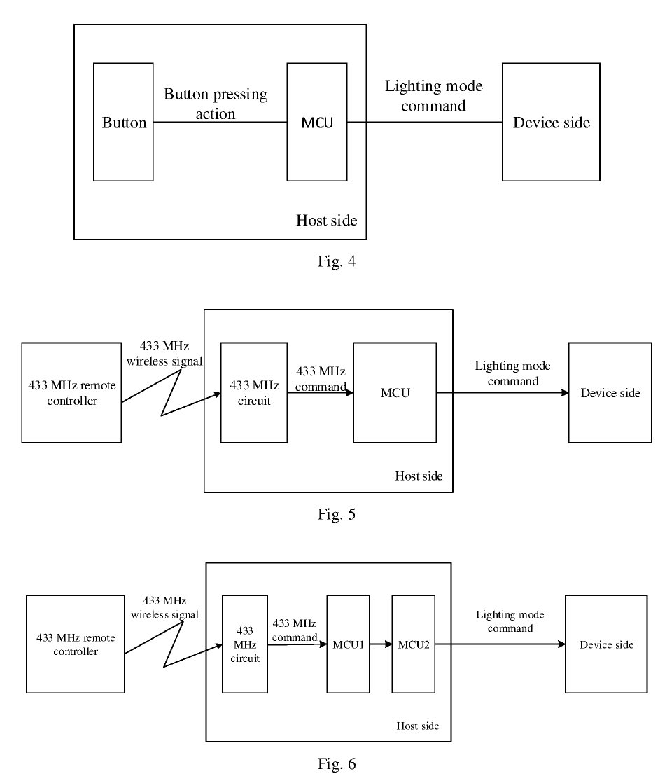

Referring to FIG. 4, as for the button module, a signal output terminal of the button module is connected to the signal input terminal of the MCU, and the MCU is used for outputting a corresponding control command according to the button pressing action of a user. Specifically, encoded control commands corresponding to multiple lighting modes are preset and stored in the MCU; a controller is connected to one or more buttons, which can be implemented by adding physical or touch buttons to the controller; and the user can select the desired lighting mode by pressing the button. For example, in the case where the controller is connected to one button, the corresponding lighting mode is determined based on the number of times the user presses the button, a button command is issued, and the controller selects an encoded control command corresponding to the lighting mode based on the button command and outputs the encoded control command to an encoding control module; and in the case where the controller is connected to a plurality of buttons, each of the buttons may be set to correspond to a lighting mode, the corresponding lighting mode is determined based on the button pressed by a user, a button command is issued, the controller selects an encoded control command corresponding to the lighting mode based on the button command and outputs the encoded control command to the encoding control module for an encoding operation by the MOS field-effect transistor, and the encoding control module outputs an encoded carrier voltage carrying a square wave signal (or lighting mode command) to the device side.

Referring to FIG. 5, the wireless transceiver module is implemented as a remote control manner, for example, by using a 433 MHz wireless transmitting and receiving circuit. The host side is provided with a 433 MHz circuit, a 433 MHz remote controller transmits information to the 433 MHz circuit by transmitting a 433 MHz wireless signal, and the MCU acquires and parses the information transmitted to the 433 MHz circuit. For example, a user presses the button corresponding to one of the lighting modes on the 433 MHz remote controller to select the lighting mode intended by the user, and sends out a 433 MHz remote control command; and the 433 MHz circuit on the host side receives the remote control command, the MCU outputs a corresponding encoded control command to the encoding control module according to the remote control command for an encoding operation by the MOS field-effect transistor, and the encoding control module outputs an encoded carrier voltage carrying a square wave signal (or lighting mode command) to the device side.

Further, since the 433 MHz wireless signal has a high requirement for real-time response, if the MCU delays processing due to other tasks, for example, the MCU is insufficient in performance due to handling of multiple tasks (such as sensor management, lighting effect calculation, and communication protocol processing), real-time reception of the 433 MHz remote control command may be blocked, resulting in signal loss or false trigger.

In order to optimize the performance of MCU and improve the real-time processing effect of 433 MHz wireless signals, referring to FIG. 6, this embodiment also provides an implementation manner of setting dual MCUs, in which a signal input terminal of the first MCU is connected to the signal output terminal of the signal receiving module, a signal output terminal of the first MCU is connected to a signal input terminal of the second MCU, and a signal output terminal of the second MCU is connected to the MOS field-effect transistor of the power supply encoding circuit.

Specifically, the host side is provided with the 433 MHz circuit, and the 433 MHz circuit is used for monitoring the remote control commands of the 433 MHz remote controller; the first MCU processes a remote control command and outputs the control command to the second MCU; the second MCU determines the corresponding lighting mode according to the control command, selects an encoded control command corresponding to the lighting mode, and outputs the encoded control command to the encoding control module for an encoding operation by the MOS field-effect transistor; and the encoding control module outputs an encoded carrier voltage carrying a square wave signal (or lighting mode command) to the device side.

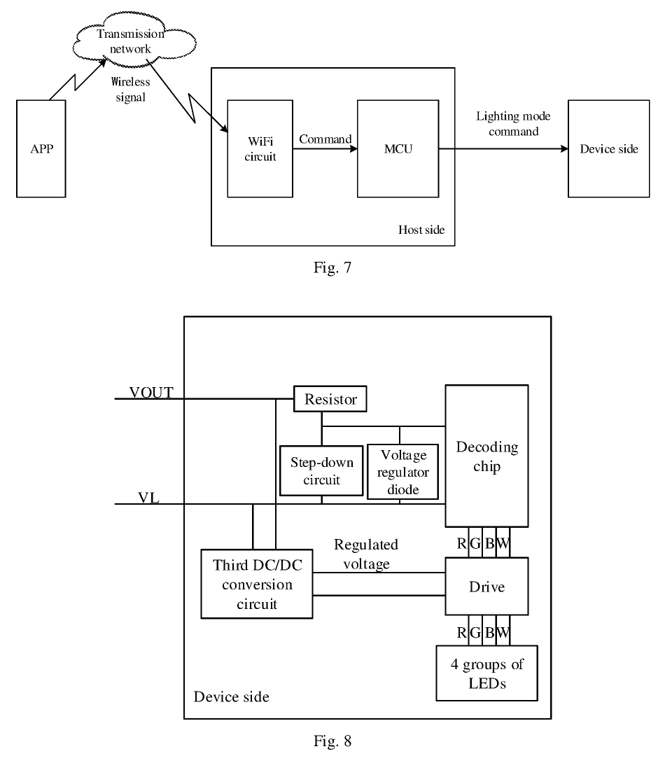

Referring to FIG. 7, in the case where the WiFi communication module is implemented as a remote control manner, a user selects the intended lighting mode using an application (APP); the APP sends out a wireless signal through a wireless network, the wireless signal is finally received by a WiFi circuit arranged on the host side after being transmitted through transmission networks such as a cloud server, and a control command is generated and sent to the MCU; after receiving the control command, the MCU determines the corresponding lighting mode, selects an encoded control command corresponding to the lighting mode, and outputs the encoded control command to the encoding control module for an encoding operation by the MOS field-effect transistor; and the encoding control module outputs an encoded carrier voltage carrying a square wave signal (or lighting mode command) to the device side.

Similarly, dual MCUs can also be set for the WiFi communication module. The first MCU is used for generating control commands based on wireless signals sent by the APP, and sending the control commands to the second MCU. The second MCU is used for determining the corresponding lighting modes based on the control commands, selecting the encoded control commands corresponding to the lighting modes, and outputting the encoded control commands to the encoding control module for encoding operations by the MOS field-effect transistor.

The various signal receiving modules provided in this embodiment provide users with different ways to select the desired lighting modes through the remote controller, APP, and buttons, which meets the needs of users in different usage scenarios.

Further, in this embodiment, the second voltage output terminal of the power supply encoding circuit may also be connected to the signal receiving module for providing the required power supply voltage to some circuits or components in the wireless receiving module and the WiFi communication module, thus further simplifying wiring.

In this embodiment, a general-purpose MCU may be employed as the MCU to perform the control functions of the MCU on the host side, which will not be repeated herein.

Referring to FIG. 8, the device side includes a decoding circuit, a drive circuit, and LED lamp beads, where the first voltage output terminal of the power supply encoding circuit is separately connected to a signal input terminal of the decoding circuit and a voltage input terminal of the drive circuit by means of the dual-wire power line, a signal output terminal of the decoding circuit is connected to a signal input terminal of the drive circuit, and an output terminal of the drive circuit is connected to the LED lamp beads.

The decoding circuit includes a voltage regulator circuit and a decoding chip. In this embodiment, the voltage regulator circuit is composed of a resistor, a step-down circuit, and a voltage regulator diode. An input terminal of the voltage regulator circuit is connected to the first voltage output terminal of the power supply encoding circuit, an output terminal of the voltage regulator circuit is connected to a signal input terminal of the decoding chip, and a signal output terminal of the decoding chip is connected to the signal input terminal of the drive circuit.

After a voltage input terminal of the decoding circuit obtains the carrier voltage VOUT of the host side through the dual-wire power line, the decoding circuit first performs voltage step-down and regulation on the carrier voltage VOUT through the resistor, the step-down circuit, and the voltage regulator diode, and then transmits the stepped-down voltage to the signal input terminal of the decoding chip; and the decoding chip decodes a lamp bead control signal corresponding to the color such as R, G, B or W, color temperature and brightness of each LED lamp bead from the square wave signals carried by the stepped-down voltage, and transmits the lamp bead control signal corresponding to the color, color temperature and brightness of the LED lamp bead to the signal input terminal of the drive circuit through the signal output terminal.

Specifically, the decoding chip in this embodiment is selected from P9873A or P9874 series chips, and is used for reading the square wave signals in the carrier voltage VOUT and decoding the signals.

The drive circuit includes a third DC/DC conversion circuit and a control circuit, where a voltage output terminal of the third DC/DC conversion circuit is connected to a voltage input terminal of a driver chip, and an output terminal of the driver chip is connected to the LED lamp beads.

After the carrier voltage VOUT of the host side transmitted via the dual-wire power line is obtained by the voltage input terminal of the drive circuit, the third DC/DC conversion circuit performs voltage conversion on the carrier voltage VOUT, and the converted driving voltage is output to a voltage input terminal of the control circuit through a voltage output terminal, so that the driving voltage suitable for the LED lamp beads is obtained.

After obtaining a driving voltage and a lamp bead control signal, the control circuit controls the corresponding LED map beads to light up according to the driving voltage and the lamp bead control signal, thus achieving the desired lighting mode for a user.

Specifically, in this embodiment, the LED lamp beads corresponding to each device side are independent and connected in parallel with the other LED lamp beads corresponding to the other device sides. In the decoding process, the local address can be written individually into the decoding chip on each device side in advance, and the lighting mode that the current LED lamp beads should execute is determined based on the address obtained by decoding the carrier voltage VOUT and the address corresponding to the current decoding chip, so that the lighting mode that the LED lamp beads on each device side need to execute can be obtained; and of course, a group control command can also be obtained by decoding without address comparison, and the LED lamp beads at all device sides directly execute the same lighting mode according to the group control command.

Taking landscape lamps as an example again, a voltage output by a transformer of one landscape lamp is used for supplying power to the host side, the host side is connected to five landscape lamps through two power lines, and all the landscape lamps are connected in parallel; after receiving a remote control command sent by a user through the 433 MHz remote controller, the host side sends out a group control command to the landscape lamps via a square wave voltage formed by encoding through the dual-wire power lines, achieving simultaneous lighting of the five lamps in the same color (such as red), or in a mixed color of seven colors (such as red, yellow, green, indigo, blue, purple, and white) gradually changing, etc.; and the five lamps may also be separately controlled according to the remote control commands of the 433 MHz remote controller, so that the five lamps are enabled to light up in different colors (for example, each of the five lamps is enabled to light up in one of the five colors, including red, green, blue, yellow and indigo), or are enabled to light up in different colors at different rhythms.

According to the present disclosure, by coupling a power supply voltage with coded signals through the power supply encoding circuit, power supply and signal transmission are completed simultaneously by using the dual-wire power line, which eliminates the need for independent communication lines in the traditional lighting control systems, greatly reduces the number of cables and the complexity of wiring, is especially suitable for multi-lighting device control scenarios, and reduces construction and maintenance costs. The first DC/DC conversion circuit provides the output voltage higher than the loop voltage for the device side, ensuring that the lowest voltage in the carrier voltage during long-distance transmission can also guarantee the integrity of the carried signals; and the second DC/DC conversion circuit provides stable low-voltage power supply for the MCU to avoid power supply noise affecting the control logic, thus realizing a hierarchical power supply design. The power supply encoding circuit superimposes the power supply voltage and the output voltage of the first DC/DC conversion circuit into a carrier voltage carrying square wave signals through the combination of the MOS field-effect transistor and the isolation diode. The decoding circuit on the device side employs P9873A or P9874 series chips, and filters out voltage fluctuation noise through the voltage regulator circuit to ensure the accurate parsing of the control commands, thus avoiding malfunctions caused by voltage ripple or load mutation.

The preferred embodiments of the present disclosure have been specifically described above, but the creation of the present disclosure is not limited to the described embodiments. Those skilled in the art can make various equivalent variations or replacements without departing from the spirit of the present disclosure, and these equivalent variations or replacements shall be included in the scope defined by the claims of the present disclosure.

What is claimed is:

1. A lighting device control system, comprising a host side and at least one device side, wherein
the host side comprises a power transformer, a power supply encoding circuit, a signal receiving module, and a microcontroller unit (MCU);
an output terminal of the power transformer is connected to a voltage input terminal of the power supply encoding circuit, a signal output terminal of the signal receiving module is connected to a signal input terminal of the MCU, and a signal output terminal of the MCU is connected to a signal input terminal of the power supply encoding circuit;
the device side comprises a decoding circuit, a drive circuit, and light emitting diode (LED) lamp beads; and
a first voltage output terminal of the power supply encoding circuit is separately connected to a signal input terminal of the decoding circuit and a voltage input terminal of the drive circuit via a dual-wire power line, a signal output terminal of the decoding circuit is connected to a signal input terminal of the drive circuit, and an output terminal of the drive circuit is connected to the LED lamp beads.

2. The lighting device control system according to claim 1, wherein the power supply encoding circuit comprises a metal-oxide-semiconductor (MOS) field-effect transistor, a first direct current to direct current (DC/DC) conversion circuit, a second DC/DC conversion circuit, and an isolation diode;
a gate electrode of the MOS field-effect transistor is connected to the signal output terminal of the MCU, a source electrode of the MOS field-effect transistor is connected to the output terminal of the power transformer, and a drain electrode of the MOS field-effect transistor and a cathode of the isolation diode are connected to a live wire of the dual-wire power line, serving as the first voltage output terminal of the power supply encoding circuit;
an input terminal of the first DC/DC conversion circuit is connected to the output terminal of the power transformer, and an output terminal of the first DC/DC conversion circuit is separately connected to an anode of the isolation diode and an input terminal of the second DC/DC conversion circuit; and
an output terminal of the second DC/DC conversion circuit is connected to a voltage input terminal of the MCU as a second voltage output terminal of the power supply encoding circuit.

3. The lighting device control system according to claim 2, wherein an output voltage at the output terminal of the first DC/DC conversion circuit is less than an output voltage of the power transformer and greater than a loop voltage of the power transformer.

4. The lighting device control system according to claim 3, wherein the output voltage at the output terminal of the first DC/DC conversion circuit is greater than an operating voltage of the device side.

5. The lighting device control system according to claim 2, wherein an output voltage at the first voltage output terminal of the power supply encoding circuit is a carrier voltage formed by superposition of the output voltage of the power transformer and the output voltage of the first DC/DC conversion circuit.

6. The lighting device control system according to claim 2, wherein the second voltage output terminal of the power supply encoding circuit is connected to the voltage input terminal of the MCU.

7. The lighting device control system according to claim 2, wherein the second voltage output terminal of the power supply encoding circuit is connected to a voltage input terminal of the signal receiving module.

8. The lighting device control system according to claim 1, wherein the MCU comprises a first MCU and a second MCU;
a signal input terminal of the first MCU is connected to the signal output terminal of the signal receiving module, and a signal output terminal of the first MCU is connected to a signal input terminal of the second MCU; and
a signal output terminal of the second MCU is connected to the MOS field-effect transistor in the power supply encoding circuit.

9. The lighting device control system according to claim 1, wherein the decoding circuit comprises a voltage regulator circuit and a decoding chip, an input terminal of the voltage regulator circuit is connected to the first voltage output terminal of the power supply encoding circuit, an output terminal of the voltage regulator circuit is connected to a signal input terminal of the decoding chip, and a signal output terminal of the decoding chip is connected to a signal input terminal of a driver chip.

10. The lighting device control system according to claim 9, wherein the drive circuit comprises a third DC/DC conversion circuit and the driver chip, a voltage output terminal of the third DC/DC conversion circuit is connected to a voltage input terminal of the driver chip, and an output terminal of the driver chip is connected to the LED lamp beads.
